(19) United States
(12) Patent Application Publication
(10) Pub. No.: US 2014/0132384 A1
(43) Pub. Date: May 15, 2014

(54) WIREWOUND INDUCTOR OF SWITCHING POWER SUPPLY AND SWITCHING POWER SUPPLY WITH THE WIREWOUND INDUCTOR

(71) Applicant: NVIDIA Corporation, Santa Clara, CA (US)

(72) Inventor: Bo Su, Shenzhen (CN)

(21) Appl. No.: 13/910,989

(22) Filed: Jun. 5, 2013

(30) Foreign Application Priority Data
Nov. 9, 2012 (CN) 201210449298.5

(51) Int. Cl. H01F 38/14

(52) U.S. Cl. CPC H01F 38/14
USPC 336/196

(57) ABSTRACT

The present invention provides a wirewound inductor of a switching power supply and a switching power supply with the wirewound inductor. The wirewound inductor comprises a magnetic core and a winding wound on the magnetic core. A buffering cushion is disposed between the magnetic core and the winding. The wirewound inductor provided by the present invention is provided with the buffering cushion between the magnetic core and the winding to absorb the dimension changes of the magnetic core caused by the magnetostriction phenomenon, and thus the relative positions of the components are maintained, the collision between the magnetic core and the winding can be prevented, and then the noise is reduced.

### CROSS-REFERENCE TO RELATED APPLICATIONS

This application claims priority to Chinese Patent Application No. 201210449298.5, filed on Nov. 9, 2012, which is hereby incorporated by reference in its entirety.

1. Field of Invention

The present invention relates generally to a switching power supply, in particular, to a wirewound inductor of a switching power supply and a switching power supply with the wirewound inductor.

2. Background

The switching power supply has displaced the linear power supply gradually and been applied to various electronic products by virtue of its many advantages, such as a small volume, a low weight, a large range of the input voltage, a low heat consumption and so on. The major components included in the switching power supply comprise a wirewound inductor. The current in the winding of the wirewound inductor of the switching power supply usually exceeds 20 Å and it is well-known that the transient loading of the switching power supply changes quickly, and thus it leads to an obvious magnetostriction phenomenon generated in the magnetic body (i.e., the magnetic core of the wirewound inductor). The magnetostriction refers to the dimension changes in every direction due to the change of the magnetization.

The magnetostriction phenomenon leads to a natural vibration in the magnetic body and then leads to a collision between the magnetic core and the winding, while this vibration and collision generate the boring noise in the switching power supply. As previously mentioned, the vibration induced by the magnetostriction phenomenon belongs to an inevitable natural phenomenon occurring in the magnetic body. And usually, the decibel value of the noise generated by the collision is greater than the noise generated by the vibration, and therefore it can reduce the decibel value of the noise in the switching power supply effectively by reducing the noise generated by the collision.

Therefore, there is a need of providing a wirewound inductor of a switching power supply and a switching power supply with the wirewound inductor to solve the above problem in the prior art.

### SUMMARY OF THE INVENTION

In order to solve the above problem, a wirewound inductor of a switching power supply is provided according to one aspect of the present invention, which comprises a magnetic core and a winding wound on the magnetic core. A buffering cushion is disposed between the magnetic core and the winding. The buffering cushion is formed of an elastic material, and a thickness of the buffering cushion is greater than a radial clearance between the magnetic core and the winding.

Preferably, the buffering cushion is formed of an elastic material with high temperature resistance.

Preferably, the buffering cushion covers an area of the magnetic core corresponding to the winding.

Preferably, the buffering cushion is tubular.

Preferably, the buffering cushion is provided with an axial slit extending along an axial direction of the wirewound inductor.

Preferably, a width of the axial slit is smaller than or equal to ¾ of a circumference of the buffering cushion.

Preferably, the buffering cushion is provided with a circumferential slit extending along a circumferential direction of the wirewound inductor.

Preferably, the buffering cushion is provided with a plurality of circumferential slits, the plurality of circumferential slits are distributed uniformly.

Preferably, the buffering cushion is provided with a plurality of heat-dissipating holes.

Preferably, the buffering cushion is formed of a poor conductor of magnetism.

A switching power supply is further provided according to another aspect of the present invention, which has a wirewound inductor. The wirewound inductor comprises a magnetic core and a winding wound on the magnetic core. A buffering cushion is disposed between the magnetic core and the winding. The buffering cushion is formed of an elastic material, and a thickness of the buffering cushion is greater than a radial clearance between the magnetic core and the winding.

Preferably, the buffering cushion is formed of an elastic material with high temperature resistance.

Preferably, the buffering cushion covers an area of the magnetic core corresponding to the winding.

Preferably, the buffering cushion is tubular.

Preferably, buffering cushion is provided with an axial slit extending along an axial direction of the wirewound inductor.

Preferably, a width of the axial slit is smaller than or equal to ¾ of a circumference of the buffering cushion.

Preferably, the buffering cushion is provided with a circumferential slit extending along a circumferential direction of the wirewound inductor.

Preferably the buffering cushion is provided with a plurality of circumferential slits, the plurality of circumferential slits are distributed uniformly.

Preferably, the buffering cushion is provided with a plurality of heat-dissipating holes.

Preferably, the buffering cushion is formed of a poor conductor of magnetism.

The wirewound inductor provided by the present invention is provided with the buffering cushion between the magnetic core and the winding to absorb the dimension changes of the magnetic core caused by the magnetostriction phenomenon, and thus the relative positions of the components are maintained, the collision between the magnetic core and the winding can be prevented, and then the noise is reduced.

A serial of simplified conceptions are incorporated into the summary of the invention, which will be further described in more detail in the detailed description. The summary of the invention neither implies that it is intended to limit the essential features and necessary technical features of the technical solution to be protected, nor implies that it is intended to define the protection scope of the technical solution to be protected.

Advantages and features of the present invention will be described in detail below in connection with the accompanying drawings.

### BRIEF DESCRIPTION OF THE DRAWINGS

The following drawings of the present invention as a part of the present invention herein are used for understanding of the present invention, the embodiments and the descriptions thereof are illustrated in the drawings for explaining the principle of the present invention. In the drawings,

FIG. 1 is a schematic view of the wirewound inductor according to one embodiment of the present invention;

FIG. 2 is a schematic view of the buffering cushion according to one embodiment of the present invention; and

FIG. 3 is a schematic view of the buffering cushion according to another embodiment of the present invention.

### DETAILED DESCRIPTION

A plenty of specific details are presented so as to provide more thoroughly understanding of the present invention in the description below. However, the present invention may be implemented without one or more of these details, as is obvious to those skilled in the art. In other examples, some of the technical features known in the art are not described so as to avoid confusions with the present invention.

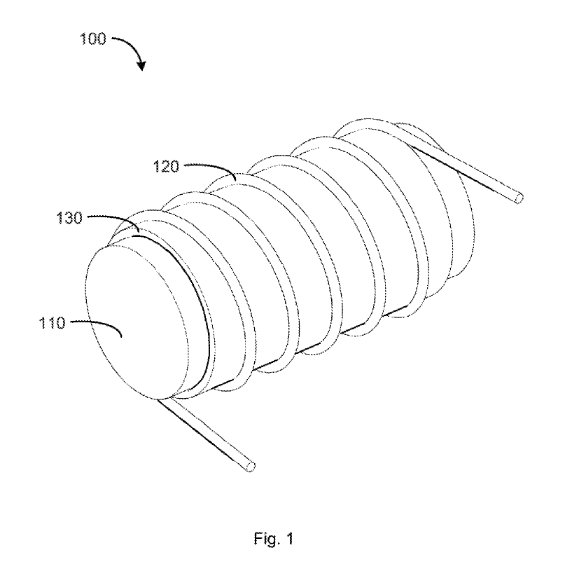

According to one aspect of the present invention, a wirewound inductor of a switching power supply (hereinafter referred to as the wirewound inductor) is provided. FIG. 1 is a schematic view of the wirewound inductor according to one embodiment of the present invention. The wirewound inductor will be described in details below in combination with FIG. 1.

As shown in FIG. 1, the wirewound inductor 100 comprises a magnetic core 110 and a winding 120. The magnetic core 110 is formed of a magnetic conductive material. The magnetic conductive material comprises, but not limits to pure iron, mild steel, iron-silicon alloy, iron-aluminum alloy, iron-silicon-aluminum alloy, nickel-iron alloy, iron-cobalt alloy and/or one or more of soft magnetic materials. The winding 120 is wound on the magnetic core 110. The winding 120 may comprise a metal wire with a higher electric conductivity (for example, a silver wire, a copper wire and an aluminum wire, etc.) and an insulating layer wrapped on the surface of the metal wire.

In order to adapt to the magnetostriction phenomenon generated in the magnetic core 110 after electrifying the winding 120, a radial clearance between the magnetic core 110 and the winding 120 may be disposed, that is, the inner diameter of the winding 120 is slightly greater than the external diameter of the magnetic core 110. A buffering cushion 130 may be disposed in the radial clearance between the magnetic core 110 and the winding 120. The buffering cushion 130 may be formed of an elastic material such as a rubber, and the thickness of the buffering cushion 130 is greater than the radial clearance between the magnetic core 110 and the winding 120. Under a free state, the buffering cushion 130 is pressed by the magnetic core 110 and the winding 120 and generates elastic deformation. Thus, even if the changes of the transient loading in the winding 120 lead to the dimension reduction of the magnetic core 110, it also does not generate the clearances between the magnetic core 110 and the buffering cushion 130 as well as between the buffering cushion 130 and the winding 120. Therefore, it does not generate the noise caused by the collision. Likewise, even if the dimension of the magnetic core 110 increases because of the changes of the transient loading in the winding 120, there is also no effect on the dimension increase of the magnetic core 110, since the buffering cushion 130 is formed of the elastic material.

On the one hand, the current with a larger current intensity usually runs in the winding 120, and it leads to the heat generated by the winding 120, and on the other hand, the continual changes of the intensity and direction of the magnetic field in the magnetic core 110 lead to the drastic movement of the molecular in the magnetic core 110, and thus the magnetic core 110 also generates heat. Therefore, preferably, the buffering cushion 130 may be formed of an elastic material with a high temperature resistance. According to the application of the switching power supply having this wirewound inductor 100 and in view of the current and the changes thereof in the winding 120, those skilled in the art may choose the material of the buffering cushion 130 reasonably.

In order to save materials and reduce costs, preferably, the buffering cushion 130 may only covers the area of the magnetic core 110 corresponding to the winding 120 when the winding 120 does not cover the magnetic core 110 entirely.

During the manufacture of the wirewound inductor, the magnetic core 110 is usually covered with the buffering cushion 130 firstly and then the wire is wound on the magnetic core 110 covered with the buffering cushion 130. In order to fix the buffering cushion 130 onto the magnetic core 110 conveniently and benefit to fulfill the standardization production of each component, preferably, the buffering cushion 130 may be tubular.

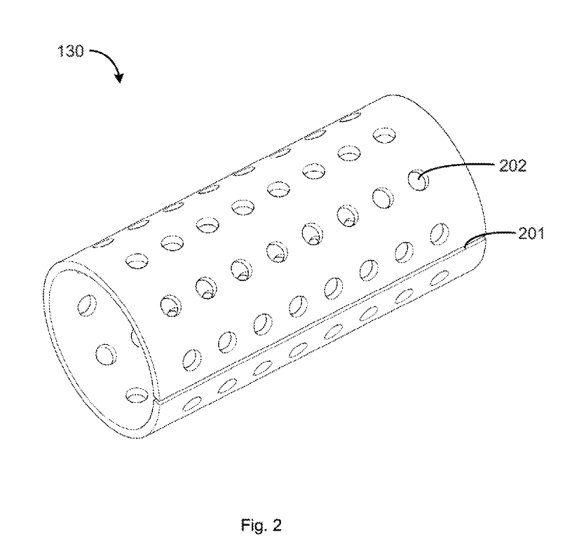

According to one aspect of the present invention, the buffering cushion 130 may be provided with an axial slit 201 extending along an axial direction of the wirewound inductor, as shown in FIG. 2. The axial slit 201 runs throughout the buffering cushion 130 in the axial length. The axial slit 201 can increase the elasticity of the buffering cushion 130 along the radial direction, and it is easy to mount the buffering cushion 130 onto the magnetic core 110. Preferably, the buffering cushion 130 is provided with only one axial slit 201 to ensure that the buffering cushion 130 is a one-piece and unitary member. The width of the axial slit 201 may be regulated according to the dimension of the buffering cushion 130. However, in order to avoid that the magnetic core 110 contacts with the winding 120, preferably, the width of the axial slit 201 may be smaller than or equal to ¾ of the circumference of the buffering cushion 130, so that the buffering cushion 130 covers ¾ of the circumference of the magnetic core 110 at least.

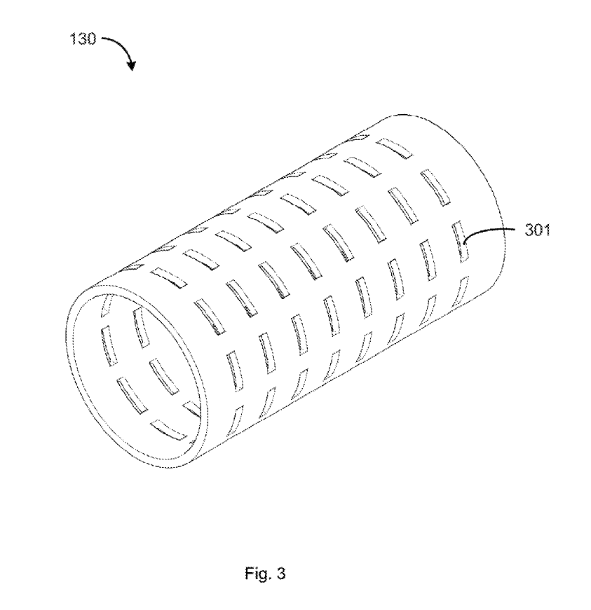

According to another aspect of the present invention, the buffering cushion 130 may be provided with a circumferential slit 301 extending along a circumferential direction of the wirewound inductor, as shown in FIG. 3. The circumferential slit 301 is disposed discontinuously on the circumference of the tubular buffering cushion 130 to ensure the buffering cushion 130 is a one-piece and unitary member. The circumferential slit 301 is not limit to the rectangle as shown in FIG. 3 and may be other shapes. A plurality of the circumferential slits 301 may be arranged in a matrix as shown in FIG. 3, or the circumferential slits 301 may be staggered. Furthermore, the circumferential slit 301 may also run through the whole circumference of the buffering cushion 130, that is, the circumferential slit 301 may segment the buffering cushion 130 into a plurality of independent parts. It should be noted that the buffering cushion 130 may be provided with one circumferential slit 301, or be provided with a plurality of the circumferential slits 301. The circumferential slit 301 has no effect on the fixing of the buffering cushion 130 on the magnetic core 110. The elasticity of the buffering cushion 130 along the axial direction can be increased by disposing the circumferential slit 301 on the buffering cushion 130. The circumferential slit 301 can also increase the elasticity of the buffering cushion 130 in the radial direction. The elasticity of the buffering cushion 130 in the axial direction and radial direction caused by the circumferential slit 301 relates to the shape and arrangement of the circumferential slit 301. Those skilled in the art can arrange the circumferential slit 301 as needed. In order to obtain the buffering cushion 130 having the uniform elasticity, preferably, the plurality of circumferential slits 301 are arranged on the buffering cushion 130 uniformly.

As mentioned above, the magnetic core 110 and the winding 120 can generate heat, and therefore, a plurality of the heat-dissipating holes 202 may preferably be disposed on the buffering cushion 130, as shown in FIG. 2. The heat generated by the magnetic core 110 is diffused into the environment by the heat-dissipating holes 202. The convection of the heat of the magnetic core 110 and the heat of the winding 120 is formed. It benefits to the heat transfer. It should be noted that the plurality of circumferential slits 301 may also be used for dissipating heat when circumferential slits 301 are disposed on the buffering cushion 130. The heat-dissipating holes 202 and the circumferential slits 301 have a certain overlap in function, but it does not mean that the two cannot both exist on the buffering cushion 130 simultaneously.

In addition, in order to avoid the buffering cushion 130 effecting on the magnetic field in the magnetic core 110, preferably, the buffering cushion is formed of a poor conductor of magnetism.

According to another aspect of the present invention, a switching power supply is further provided. The switching power supply comprises any kind of the wirewound inductor mentioned above. The shape and structure of each component included in the wirewound inductor may refer to the description of the respective part mentioned above, and it is no longer described in details herein.

In conclusion, the wirewound inductor provided by the present invention is provided with the buffering cushion between the magnetic core and the winding to absorb the dimension changes of the magnetic core caused by the magnetostriction phenomenon, and thus the relative positions of the components are maintained, the collision between the magnetic core and the winding can be prevented, and then the noise is reduced.

The present invention has been described by the above-mentioned embodiments. However, it will be understood that the structures and the functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). The above-mentioned embodiments are for the purpose of demonstration and description and not for the purpose of limiting the present to the scope of the described embodiments. Moreover, those skilled in the art could appreciated that the present invention is not limited to the above mentioned embodiments and that various modifications and adaptations in accordance of the teaching of the present invention may be made within the scope and spirit of the present invention. The protection scope of the present invention is further defined by the following claims and equivalent scope thereof.

What is claimed is:

1. A wirewound inductor of a switching power supply, comprising:
a magnetic core and a winding wound on the magnetic core; and
a buffering cushion being disposed between the magnetic core and the winding, the buffering cushion being formed of an elastic material, and a thickness of the buffering cushion being greater than a radial clearance between the magnetic core and the winding.

2. The wirewound inductor according to claim 1, wherein the buffering cushion is formed of an elastic material with high temperature resistance.

3. The wirewound inductor according to claim 1, wherein the buffering cushion covers an area of the magnetic core corresponding to the winding.

4. The wirewound inductor according to claim 1, wherein the buffering cushion is tubular.

5. The wirewound inductor according to claim 4, wherein the buffering cushion is provided with an axial slit extending along an axial direction of the wirewound inductor.

6. The wirewound inductor according to claim 5, wherein a width of the axial slit is smaller than or equal to ¾ of a circumference of the buffering cushion.

7. The wirewound inductor according to claim 4, wherein the buffering cushion is provided with a circumferential slit extending along a circumferential direction of the wirewound inductor.

8. The wirewound inductor according to claim 7, wherein the buffering cushion is provided with a plurality of circumferential slits, the plurality of circumferential slits are distributed uniformly.

9. The wirewound inductor according to claim 1, wherein the buffering cushion is provided with a plurality of heat-dissipating holes.

10. The wirewound inductor according to claim 1, wherein the buffering cushion is formed of a poor conductor of magnetism.

11. A switching power supply, comprising:
a wirewound inductor, the wirewound inductor including a magnetic core and a winding wound on the magnetic core; and
a buffering cushion being disposed between the magnetic core and the winding, the buffering cushion being formed of an elastic material, and a thickness of the buffering cushion being greater than a radial clearance between the magnetic core and the winding.

12. The switching power supply according to claim 11, wherein the buffering cushion is formed of an elastic material with high temperature resistance.

13. The switching power supply according to claim 11, wherein the buffering cushion covers an area of the magnetic core corresponding to the winding.

14. The switching power supply according to claim 11, wherein the buffering cushion is tubular.

15. The switching power supply according to claim 14, wherein the buffering cushion is provided with an axial slit extending along an axial direction of the wirewound inductor.

16. The switching power supply according to claim 15, wherein a width of the axial slit is smaller than or equal to ¾ of a circumference of the buffering cushion.

17. The switching power supply according to claim 14, wherein the buffering cushion is provided with a circumferential slit extending along a circumferential direction of the wirewound inductor.

18. The switching power supply according to claim 17, wherein the buffering cushion is provided with a plurality of circumferential slits, the plurality of circumferential slits are distributed uniformly.

19. The switching power supply according to claim 11, wherein the buffering cushion is provided with a plurality of heat-dissipating holes.

20. The switching power supply according to claim 11, wherein the buffering cushion is formed of a poor conductor of magnetism.
